(19) United States
(12) Patent Application Publication
(10) Pub. No.: US 2008/0251744 A1
(43) Pub. Date: Oct. 16, 2008

(54) REMOTE ADJUSTABLE SHOCK ABSORBER

(76) Inventor: Brian Goscinski, Grayslake, IL (US)

Correspondence Address: LISA A. BRZYCKI;Gehrke & Associates, S.C., 123 North 86th Street, Wauwatosa, WI, 53226, US

(21) Appl. No.: 12/100,728

(22) Filed: Apr. 10, 2008

Related U.S. Application Data
(62) Division of application No. 10/935,456, filed on Sep. 7, 2004, now abandoned.
(60) Provisional application No. 60/500,182, filed on Sep. 4, 2003.

(51) Int. Cl. F16K 31/12

(52) U.S. Cl. 251/63.5

(57) ABSTRACT

A modified mono-tube shock is a lighter shock with less rod pressure, less seal drag, a greater range of valving, and faster heat dissipation. The shock includes an outer body, a shaft piston, a plurality of deflective discs, and a divider piston, wherein the divider piston is installed at a particular location inside the shock to create a gas chamber.

### CROSS-REFERENCE TO RELATED APPLICATIONS

The present application is a divisional application of U.S. patent application Ser. No. 10/935,456, filed Sep. 7, 2004, which is a continuation-in-part application of U.S. Provisional Patent Application No. 60/500,182, filed on Sep. 4, 2002.

### BACKGROUND OF THE INVENTION

1. Field of Invention

The present invention relates generally to a shock absorber that is adjustable. In particular, the present invention relates to a shock absorber that is remotely adjustable on the fly during operation of the vehicle.

2. Discussion of Relevant Prior Art

The purpose of the shock is to control the motion of the chassis. This is accomplished by using a valve to meter oil. The heat generated by this system then needs to be dissipated to the atmosphere.

In conventional shock absorbers, a twin tube shock includes a steel inner tube that contains a piston and a valve. The shock is filled with oil, wrapped with a plastic bag and filled with nitrogen.

Unfortunately, there are various problems inherent in this conventional shock absorber design including the fact that the steel inner tube retains heat in the most crucial area around the piston where the heat is generated. Moreover, the steel tube also takes up valuable space that could be filled with oil. Additionally, the plastic bag filled with nitrogen that is wrapped around the inner tube is actually a superior insulator that retains the heat instead of dissipating the heat. The valves are typically controlled by a small spring that is not very accurate, repeatable or long lasting. The oil that is commonly used is a mineral oil that does not dissipate heat very well, maintain viscosity and resist cavitation.

Finally, by not having the oil pressurized, the oil will develop air bubbles. When the oil in the shock absorber heats up, the viscosity of the oil significantly breaks down resulting in the shock losing its ability to dampen the motion of the chassis. Additionally, when the oil in the shock absorber cavitates, the oil is thinned out and this leads to shock fade. Therefore, it appears that the twin tube shock is designed to fade.

Another typical design of shock absorbers is the mono-tube design. Mono-tube shocks are designed for high performance use. This design is the preferred choice of Formula One, IRL, CART, WINSTON CUP, BUSH, CRAFTSMEN TRUCKS, motocross bikes, snowmobiles, and ATV's, among others. Mono-tubes, however, are also plagued with design flaws including high rod pressure and valving limitations.

What is needed, therefore, to overcome these inherent design limitations of both twin-tube and mono-tube shock absorbers is the design of a new mono-tube shock that is a lighter shock with less rod pressure, less seal drag, a greater range of valving, and faster heat dissipation.

### BRIEF SUMMARY OF THE INVENTION

According to one aspect of the invention, a modified mono-tube shock is a lighter shock with less rod pressure, less seal drag, a greater range of valving, and faster heat dissipation.

The shock includes an outer body, a shaft piston, a plurality of deflective discs, and a divider piston, wherein the divider piston is installed at a particular location inside the shock to create a gas chamber.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is an exploded view of valving according to the present invention;

FIG. 2 is an exploded view of a shock according to the present invention;

FIG. 3A is a top plan view of a piston according to the present invention;

FIG. 3B is a cross-sectional view along line A-A of FIG. 3A according to the present invention;

FIG. 3C illustrates an enlarged view of a circled area in FIG. 3B according to the present invention;

FIG. 4 is a top plan view of an alternative embodiment of the shaft housing including a steel shim according to the present invention;

FIG. 5 is a cross-sectional view along line A-A of FIG. 4 according to the present invention;

FIG. 6 illustrates a shaft housing according to the present invention;

FIG. 7 is a side view of a compression adjuster valve according to the preferred embodiment of the present invention;

FIG. 8 is a front view of a valve cap according the present invention;

FIG. 9 is a front view of an index plate according to the present invention; and

FIG. 10 is a front view of a valve body according to the present invention.

### DETAILED DESCRIPTION OF THE PREFERRED EMBODIMENT

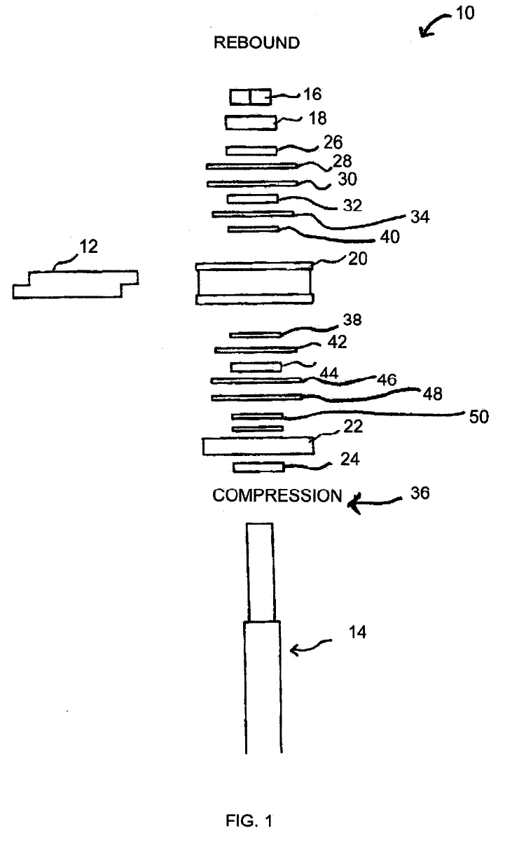

Referring to FIG. 1, an adjustable shock absorber 10 includes a wear band 12, a shaft 14, a Nylock™ nut 16, a 15×2 washer 18, a piston 20, a base plate 22, and a 15×50 disc 24. A clamp disc 26 varies in diameter but in the preferred embodiment of the present invention is 0.5 mm thick. The diameter of clamp disc 26 is used to adjust the curve from the knee out.

A 28 mm disc 28 preferably varies in thickness and quantity, but is 28 mm in diameter. 28 mm disc 28 is for adjusting the transition between a low speed and a high speed and the overall stiffness of absorber 10. A slotted 28 mm disc 30 is 28 mm in diameter but varies in thickness and the number of slots. Additionally, discs 30 may be stacked. Slotted disc 30 controls the low speed.

A 16 mm spacer 32 is 16 mm in diameter but can be stacked to equal a greater thickness. Spacer 32 is for the adjustment of the preload. A 25×15 shut off disc 34 stops the oil from bleeding back to a compression side 36. A pair of 16×10 shims 38 and 40 is optionally included in shock 10.

A 25×15 shut off disc 42 is adjacent to a 16 mm spacer 44. A 28 mm slotted disc 46 is similarly adjacent to a 28 mm disc 48 on compression side 36 of shock 10. Shock 10 further includes a clamp disc 50.

Shut off disc 34 stops oil from bleeding from one side to the other. The disc on the rebound side affects the low speed on the compression side and vice-versa. 16 mm spacer 32 is for preload adjustment of the stack. On soft valvings that do not have a pronounced knee, spacer 32 will affect the whole curve. On valvings with a pronounced curve, this will only change the curve from the knee out. 28 mm slotted disc 30 is a bypass disc that controls the low speed (from 0 up to the knee). Disc 30 is sometimes stacked with other slotted discs to obtain a larger bypass area or they can be modified with additional slots.

28 mm disc 28 is a backup disc for adjusting the transition between low speed and high speed and for overall stiffness of the stack. Softer backup discs will bend more gradually at the knee and stiffer stacks will have a sharper transition at the knee. It is possible to put a 16×0.10 in between two backup discs to smooth out the transition between bypass and the valve stack opening.

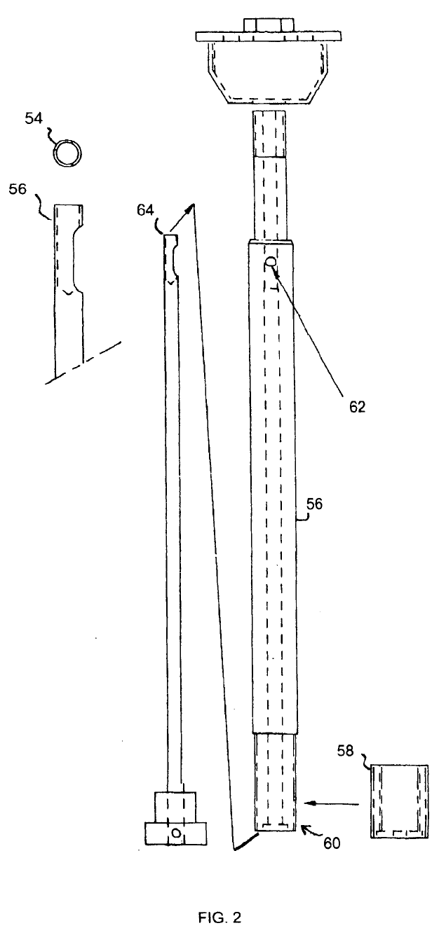

Referring to FIG. 2, an outer body 56 contains the oil, shaft piston and divider piston. Outer body 56 is made of 6061-T6 aluminum and machined from raw material to very close tolerances. Body 56 is fully threaded and has several purposes including (1) for coil over applications, (2) for extra protection from damage, and (3) for heat dissipation.

On the inside of body 56, a divider piston is installed at a very specific location to create a gas chamber. This divider piston is free floating to keep oil pressurized at all times. A synthetic oil with anti-foaming additives and high lubricity is filled to the top. A shaft piston is also installed with deflective discs. Once the air bleed is out of the piston, the rod guide seal housing is installed. While tightening the housing, excess oil is bled out of shock 10, thereby leaving a completely air free environment. At this time shock 10 is charged through the Schrader valve.

In the preferred embodiment of the present invention, a proprietary oil is used that maintains its viscosity by transferring the heat to the aluminum body which is air cooled. Shocks 10 usually run at ambient temperature. This cooling technique along with the anti-foaming additives eliminates shock fade. The process used to build the valve stack makes them very strong and durable and the bleed is accomplished through special bleed discs in the valve stack giving very precise control.

The seals in shock 10 have very minimal seal friction. Seal friction is something that is very critical to a race car. For example, a competitor's mono-tube shock requires 8 lbs of force to move the shaft and takes 14 lbs of force to keep the shaft moving. Now multiply this result by 4 for each corner of the car and you need 24 lbs of force to get the chassis to move and 56 lbs of force to keep it moving. On the contrary, shafts in shock 10 only require 4 lbs of force to move and 1 lb of force to keep them moving. This obviously affects how quickly the chassis reacts and how much the driver will be able to feel the race track.

Shaft construction is another major difference between conventional shocks and shock 10 in the present invention. The shaft in shock 10 is only preferably 7/16″ in diameter. A small shaft size does many things to improve the performance of the shock including (1) less multiplication of rod pressure, (2) less seal friction, (3) less weight, (4) less steel area to retain heat, (5) the shaft will bend before it will break, (6) high surface hardness to resist damage, and (7) special chrome plating process that extends seal life.

Shock 10 may also be modified to offer many base line valvings or custom user-defined valvings. The piston design of shock 10 is very high flowing, therefore allowing the valve stack to be tuned over a wide range of conditions. One of the main advantages of the piston in shock 10 is the ability to build in extreme amounts of low speed rebound control without affecting the compression side.

Shock 10 offers three different piston designs to suit the variety of conditions that exist. In this regard, shocks 10 are accurate, repeatable, dependable, and tunable over conventional mono-tube shock designs.

As discussed above, shock 10 is also a remote cockpit adjustable shock that is set up for rebound adjustment, dual adjustment, or compression adjustment only. All adjustments are done by turning a knob that is mounted in a comfortable position for the driver to reach. The dual adjustment is accomplished by turning one knob that will change compression and rebound dampening simultaneously. Shocks 10 are setup to primarily adjust low speed control that has the most effect on car handling. The range of adjustment is about the range of three different valved shocks. To make the adjustment easy to control, the adjusters were designed with twenty-four clicks and it takes three complete revolutions of the knob for the full range of adjustment. These features make shock 10 user friendly for all levels of experience.

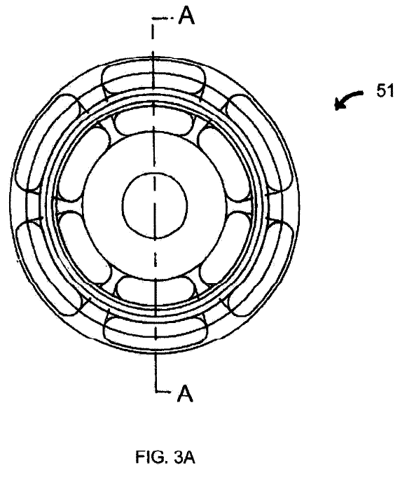

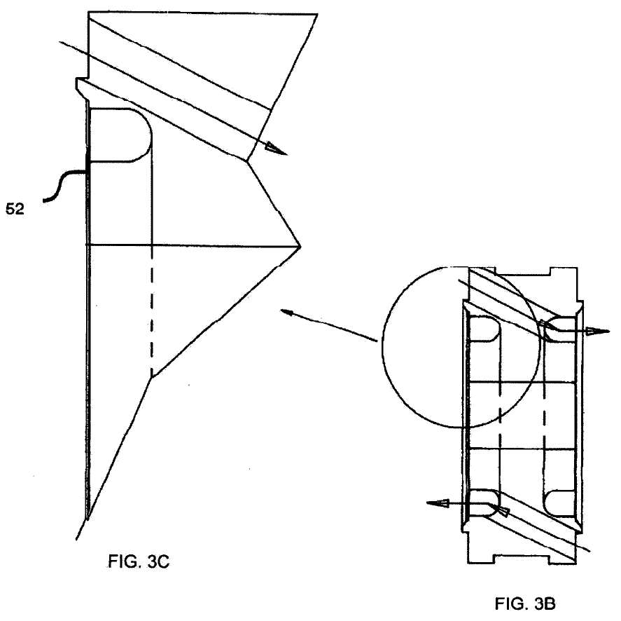

Referring to FIGS. 2-3, a digressive piston 51 is illustrated including a steel shim 52 that is mounted on the outside for rebound adjustment and on the inside for compression adjustment. A check valve 54 is used to control which direction the oil flows through a shaft 56. A threaded bushing 58 is placed over and end 60 of shaft 56 to contain an O-ring. Oil flows through an aperture 62 and is metered by an inner shaft 64. Inner shaft 64 is fitted inside main shaft 56 and is rotated by means of a worm gear set to control the flow of oil through the shaft.

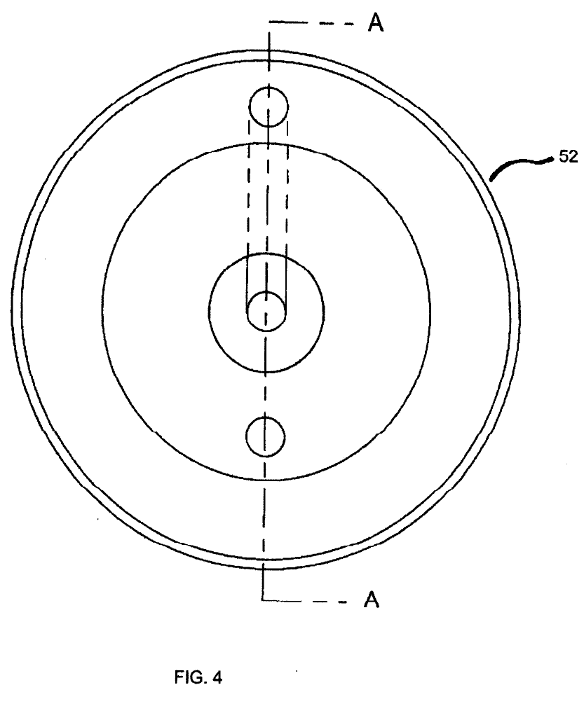

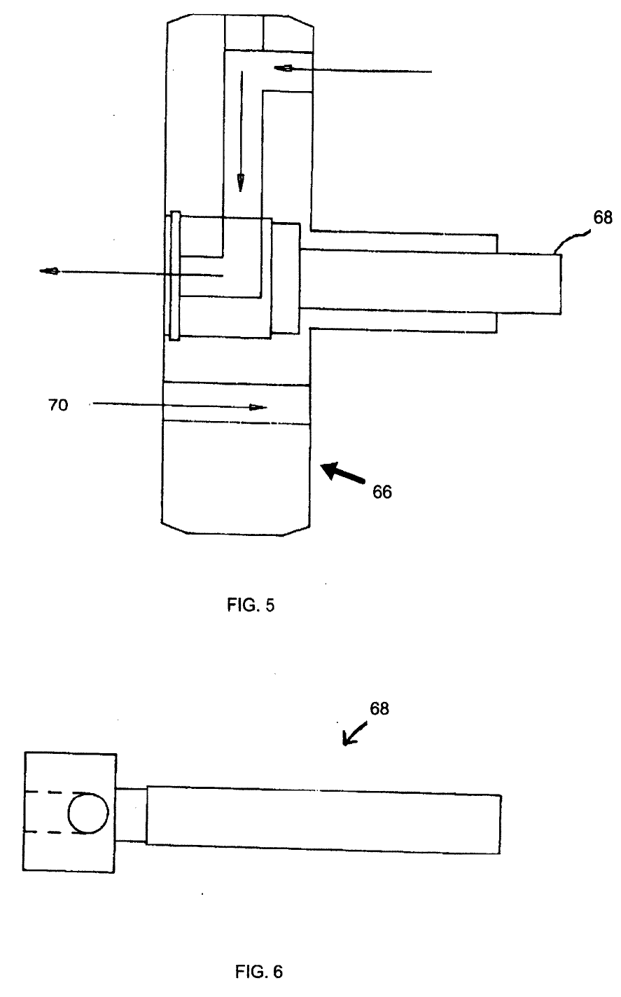

FIGS. 4-6 illustrate an alternative embodiment of the shaft housing with a steel shim according to the present invention. A steel shim 52 acts as a check valve. An adjustment shaft 68 fits into a shaft housing 66 and controls the amount of shock fluid that can pass through. Shaft 68 is rotated by means of the worm gear set that is mounted into a cap that shaft housing 66 fits into. Fluid is free to flow back to main shock body through an aperture 70.

The modified mono-tube design of shock 10 described above results in several advantages over the conventional shock including:

Shaft Position—A slotted disc allows oil to pass freely through piston 20 because of the addition of a steel shim 52 that prevents oil from flowing in the opposite direction. This allows for the low speed to be adjusted independently from compression to rebound.

Adjustable Bypass—Shock 10 uses a rotating shaft that is installed in the main shock shaft. By rotating the shaft by means of a worm gear set in the rod end assembly, the amount of shock fluid that can pass through the shaft can be precisely adjusted. It also offers a wide range of adjustability. The use of a worm gear helps to eliminate backlash there by increasing the accuracy of the adjustment.

Check Valve—Shock 10 having a check valve can be changed from a compression adjustment to a rebound adjustment or dual adjustment. The check valve is also used to control the range of adjustment and the amount of adjustment between settings.

Adjustable Rod End—Contains a worm gear shaft that mates with the inner shaft gear and has a detent and knob to allow the user to set the knob to various settings.

Remote Adjustment—The remote external adjustment is accomplished through the use of a cable and knob that is mounted in a location that the driver can adjust on the fly. This adjustment can also be performed by electronics replacing the cable/knob design.

Compression Adjustment—The compression adjustment is performed in a remote canister that is separate from the main body and done in a similar method as the adjustable bypass through the shaft. This can also be accomplished by a remote cable or electronic adjustment.

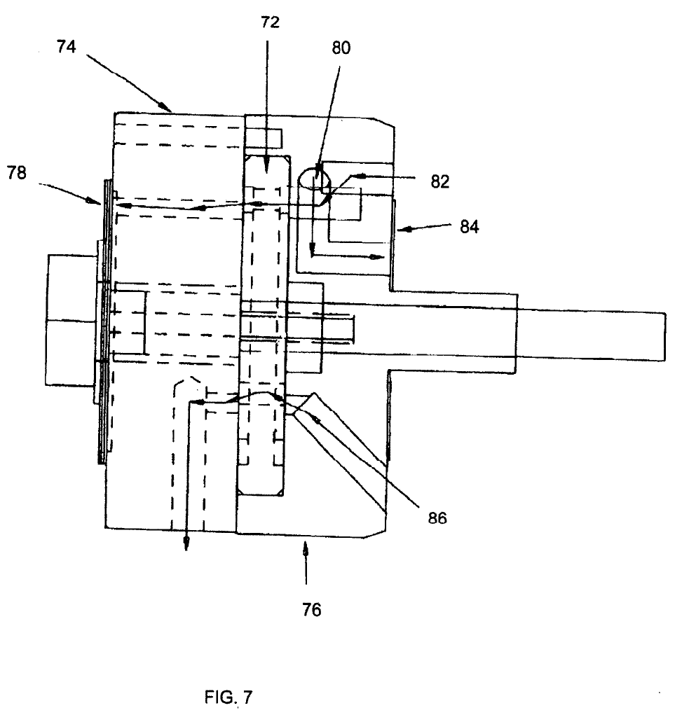

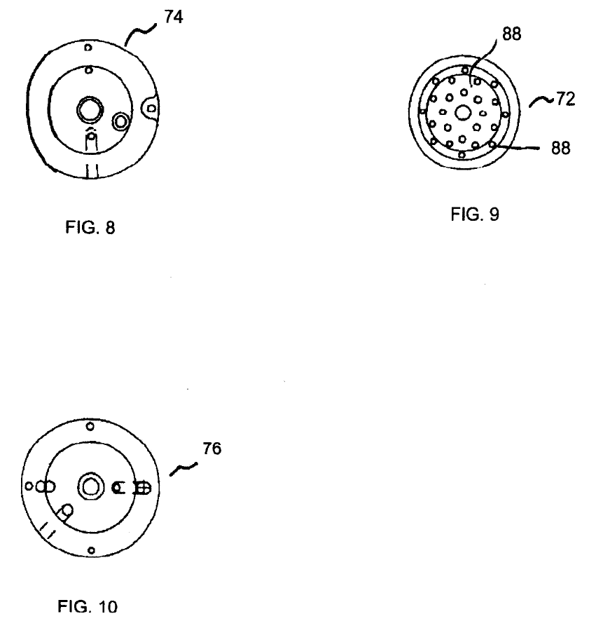

FIGS. 7-10 illustrate the preferred embodiment of a compression adjuster valve 70 of the present invention. Valve 70 includes an index plate 72, valve cap 74, valve body 76, a pop off valve 78, a return circuit 80, a pop off circuit 82, a check valve 84, and an adjustable circuit 86.

In operation, compression adjuster valve allows metering the flow by using index plate 72 with a series of holes 88 that vary in location and size, pop off valve 78, and return circuit 80 with check valve 84. Additionally, the present invention controls the bypass around the piston through the shaft and uses a check valve that can be used three different ways as illustrated in FIG. 2. As illustrated in FIG. 1, the present invention uses a check valve on the main piston. Finally, as illustrated in FIGS. 3B and 3C, the piston in designed to accept a check valve.

The scope of the application is not to be limited by the description of the preferred embodiments described above, but is to be limited solely by the scope of the claims that follow.

I claim:

1. A compression adjuster valve comprising:
an index plate having a plurality of apertures;
a valve cap;
a valve body;
a pop off valve;
a return circuit;
a pop off circuit;
a check valve; and
an adjustable circuit, wherein flow is metered using the apertures in the index plate and the apertures vary in size and location in the index plate.
